(19) United States
(12) Patent Application Publication
(10) Pub. No.: US 2009/0175514 A1
(43) Pub. Date: Jul. 9, 2009

(54) STRATIFICATION METHOD FOR OVERCOMING UNBALANCED CASE NUMBERS IN COMPUTER-AIDED LUNG NODULE FALSE POSITIVE REDUCTION

(75) Inventors: Luyin Zhao, White Plains, NY (US); Kwok Pun Lee, Flushing, NY (US); Lilla Boroczky, Mount Kisco, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/719,672

(22) PCT Filed: Nov. 21, 2005
(86) PCT No.: PCT/IB05/53843

§ 371 Date: May 18, 2007

Related U.S. Application Data
(60) Provisional application No. 60/629,752, filed on Nov. 19, 2004.

(51) Int. Cl. G06K 9/00; G06K 9/62

(52) U.S. Cl. 382/128; 382/159

(57) ABSTRACT

A method for computer aided detection (CAD) and classification of regions of interest detected within HRCT medical image data. The method includes post-CAD machine learning techniques applied to maximize specificity and sensitivity of identification of a region/volume as being a nodule or non-nodule. The regions are identified by a CAD process, and automatically segmented. A feature pool is identified and extracted from each segmented region, and processed by genetic algorithm to identify an optimal feature subset, wherein a data stratification method is used to balance the number of cases in different classes. The subset determined by GA is used to train the support vector machine to classify candidate region/volumes found within non-training data.

### RELATED APPLICATIONS

This application/patent derives from U.S. Provisional Patent Application No. 60/629, 751, filed Nov. 19, 2004, by the named applicants. The application is related to commonly-owned, co-pending Philips applications PHUS040505 (779361), PHUS040500 (778964) and PHUS040499 (778965).

The present inventions relate to computer-aided detection systems and methods. The inventions relate more closely to systems and methods for false positive reduction in computer-aided detection (CAD) results, particularly within high-resolution, thin-slice computed tomographic (HRCT) images, using a support vector machine (SVM) to implement post-CAD classification utilizing stratification to unbalanced data sets (training data sets) during CAD system training, resulting in very high specificity (reduction in the number of false positives reported), while maintaining appropriate sensitivity.

The speed and sophistication of current computer-related systems support development of faster, and more sophisticated medical imaging systems. The consequential increase in amounts of data generated for processing, and post-processing, has led to the creation of numerous application programs to automatically analyze the medical image data. That is, various data processing software and systems have been developed in order to assist physicians, clinicians, radiologists, etc., in evaluating medical images to identify and/or diagnose and evaluate medical images. For example, computer-aided detection (CAD) algorithms and systems have developed- to automatically identify “suspicious” regions (e.g., lesions) from multi-slice CT (MSCT) scans. CT, or computed tomography, is an imaging modality commonly used to diagnose disease through imaging, in view of its inherent ability to precisely illustrate size, shape and location of anatomical structures, as well as abnormalities or lesions.

CAD systems automatically detect (identify and delineate) morphologically interesting regions (e.g., lesions, nodules, microcalcifications), and other structurally detectable conditions/regions, which might be of clinical relevance. When the medical image is rendered and displayed, the CAD system marks or highlights (identifies) the investigated region. The marks are to draw the attention of the radiologist to the suspected region. For example, in the analysis of a lung image seeking possibly cancerous nodules, the CAD system will mark the nodules detected. As such, CAD systems incorporate the expert knowledge of radiologists to automatically provide a second opinion regarding detection of abnormalities in medical image data. By supporting the early detection of lesions or nodules suspicious for cancer, CAD systems allow for earlier interventions, theoretically leading to better prognosis for patients.

Most existing work for CAD and other machine learning systems follow the same methodology for supervised learning. The CAD system starts with a collection of data with known ground truth. The CAD system is “trained” on the training data to identify a set of features believed to have enough discriminatory power to distinguish the ground truth, i.e., nodule or non-nodule in non-training data. Challenges for those skilled in the art include extracting the features that facilitate discrimination between categories, ideally finding the most relevant sub-set of features within a feature pool. Once trained, the CAD system may then operate on non-training data, where features are extracted from CAD-delineated candidate regions and used for classification.

CAD systems may combine heterogeneous information (e.g. image-based features with patient data), or they may find similarity metrics for example-based approaches. The skilled artisan understands that the accuracy of any computer-driven decision-support system is limited by the availability of the set of patterns already classified by the learning process (i.e., by the training set). False positive markings (output from a CAD system) are those markings which do not point at nodules at all, but at scars, bronchial wall thickenings, motion artifacts, vessel bifurcations, etc. Where a CAD assisted outcome represents a bottom line truth (e.g., nodule) of an investigated region, the clinician would be negligent were he/she to NOT investigate the region more particularly. Those skilled in the art should understand that in a diagnostic context, “true positive” often refers to a detected nodule that is truly malignant. However, in a CAD context, a marker is considered to be a true positive marker even if it points at a benign or calcified nodule. It follows that “true negative” is not defined and a normalized specificity cannot be given in CAD. Accordingly, CAD performance is typically qualified by sensitivity (detection rate) and false positive rate or false positive markings per CT study, and as such, it is quite desirable for a CAD system to output minimal false positives.

After completion of the automated detection processes (with or without marking), most CAD systems automatically invoke one or more tools for application of user- and CAD-detected lesions (regions) to, for example, eliminate redundancies, implement interpretive tools, etc. To that end, various techniques are known for reducing false positives in CAD. For example, W. A. H. Mousa and M. A. U. Khan, disclose their false positive reduction technique entitled: “Lung Nodule Classification Utilizing Support Vector Machines,” Proc. of IEEE ICIP' 2002. K. Suzuki, S. G. Armato III, F. Li, S. Sone, K. Doi, describe an attempt to minimize false positives in: “Massive training artificial neural network (MTANN) for reduction of false positives in computerized detection of lung nodules in low-dose computed tomography”, Med. Physics 30(7), July 2003, pp. 1602-1617, as well as Z. Ge, B. Sahiner, H.-P. Chan, L. M. Hadjiski, J. Wei, N. Bogot, P. N. Cascade, E. A. Kazerooni, C. Zhou, “Computer aided detection of lung nodules: false positive reduction using a 3D gradient field method”, Medical Imaging 2004: Image Processing, pp. 1076-1082.

FPR systems are used in post-CAD processing to improve specificity. For example, R. Wiemker, et al., in their COMPUTER-AIDED SEGMENTATION OF PULMONARY NODULES: AUTOMATED VASCULATURE CUTOFF IN THIN- AND THICK-SLICE CT, 2003 Elsevier Science BV, discuss maximizing sensitivity of a CAD algorithm to effectively separate lung nodules from the nodule's surrounding vasculature in thin-slice CT (to remedy the partial volume effect). The intended end is to reduce classification errors. However, the Wiemker CAD systems and methods do not use sophisticated machine learning techniques, nor do they optimize feature extraction and selection methods for FPR. For example, while Mousa, et al., utilize support vector machines to distinguish true lung nodules from non-nodules (FPs), their system is based on a very simplistic feature extraction unit, which may limit rather than improve specificity.

Another known problem is that the number of false nodules generated by CAD algorithms is far more than true nodules (unbalanced case problem), thus lowering the performance of machine learning. The unbalanced training case problem refers to the situation in machine learning where the number of cases in one class is significantly fewer than those in another class. It is well known that such unbalance will cause unexpected behavior for machine learning. One common approach adopted by the machine learning community is to rebalance them artificially. Doing so has been called “up-sampling” (replicating cases from the minority) and “down-sampling” (ignoring cases from the majority). Provost, F. “Learning with Imbalanced Data Sets 101” AAAI 2000.

The unbalanced training case problem is especially salient in lung nodule false positive reduction. However, due to the biased goal—maintain true nodules and reduce as many false nodules as possible—instead of seeking for overall classification accuracy (the objective of most other machine learning algorithms). This invention describes a new, stratified method that is specifically suitable for such biased goal approach and overcomes the unbalanced case number problem.

It is therefore the object of this invention to provide a CAD-based system and method that realizes a decided improvement in specificity, i.e., false positive reduction, through implementation of a new stratification method, or biased goal approach, for overcoming what is known in the art as the unbalanced case problem. The result is improved specificity in the CAD process.

The inventive CAD and false positive reduction (FPR) systems as disclosed hereby include a machine-learning sub-system, the sub-system for post-CAD processing. The sub-system comprises a feature extractor, genetic algorithm (GA) for selecting the most relevant features, and support vector machine (SVM). The SVM qualifies candidate regions detected by CAD as to some ground truth fact, e.g., whether a region/volume is indeed a nodule or non-nodule, under the constraint that all true positive identifications are retained. First the CAD or FPR system must be trained on a set of training data, which includes deriving the most relevant features for use by the post-CAD machine learning SVM to classify with improved CAD specificity.

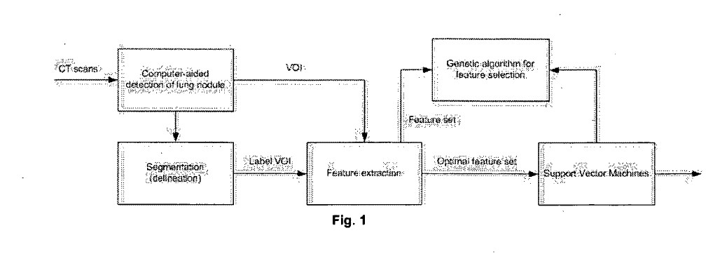

FIG. 1 is a diagram depicting a system for false positive reduction (FPR) in computer-aided detection (CAD) from Computed Tomography (CT) medical images using support vector machines (SVMs);

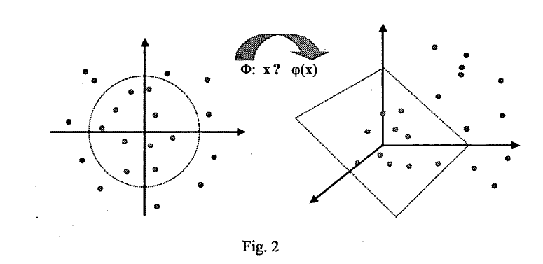

FIG. 2 is a diagram depicting the basic idea of a support vector machine;

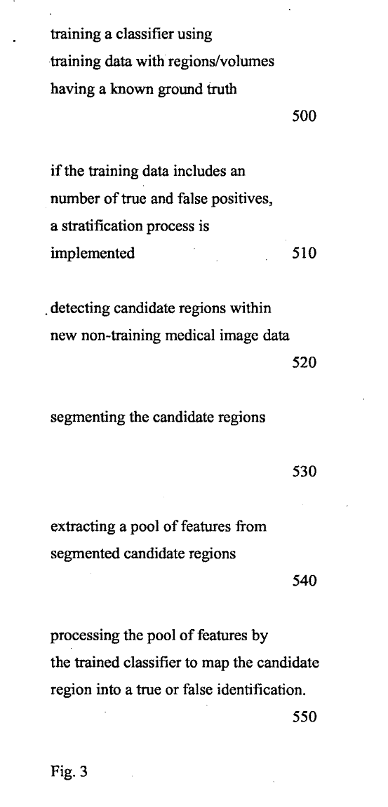

FIG. 3 is a process flow diagram identifying an exemplary process of the inventions;

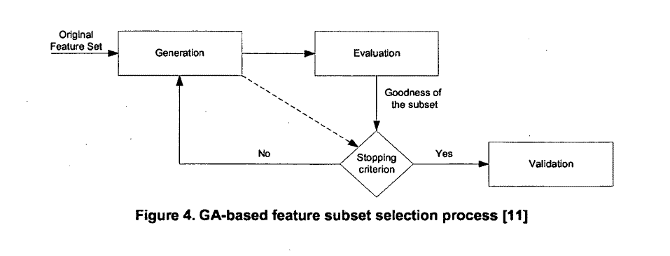

FIG. 4 depicts a GA-based feature subset selection process; and

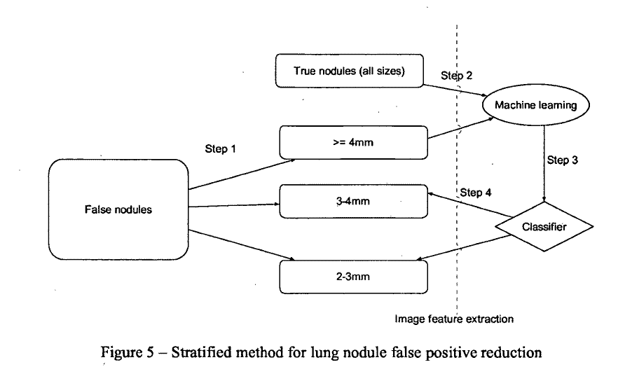

FIG. 5 is a system level diagram which highlights the stratified method for lung nodule false positive reduction; and

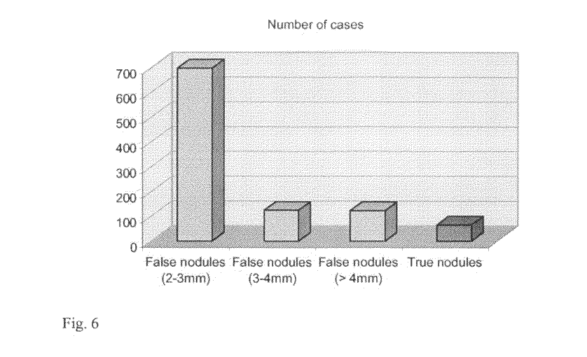

FIG. 6 provides a statistical analysis of detected false nodules, depending on nodule size.

The underlying goal of computer assistance in detecting lung nodules in image data sets (e.g., CT) is not to designate the diagnosis by a machine, but rather to realize a machine-based algorithm or method to support the radiologist in rendering his/her decision, i.e., pointing to locations of suspicious objects so that the overall sensitivity (detection rate) is raised. The principal problem with CAD or other clinical decision support systems is that inevitably false markers (so called false positives) come with the true positive marks.

Clinical studies support that measured CAD detection rates, as distinguished from measured rates of detection by trained radiologists depend on the number of reading radiologists. The more trained readers that participate in reading of suspicious lesions, microcalcifications, etc., the larger the number of lesions (within an image), which will be found. Those skilled in the art should note that any figures depicting absolute sensitivity, whether reading by CAD or skilled practitioner, may be readily misinterpreted. That is, data from clinical studies tend to support that a significant number of nodules are more readily detectable by additional CAD software, that were overlooked by reading radiologists without a CAD system. The present inventions provide for increased specificity (better FPR), while maintaining sensitivity (true nodule findings).

CAD-based systems that include false positive reduction processes, such as those described by Wiemker, Mousa, et al., etc., have one big job and that is to identify “actionable” structures detected in medical image data. Once identified (i.e., segmented), a comprehensive set of significant features is extracted and used to classify. Those skilled in the art will recognize that the accuracy of computer driven decision support, or CAD systems, is limited by the availability of a set of patterns or regions of known pathology used as the training set. Even state-of-the-art CAD algorithms, such as described by Wiemker, R., T. Blaffert¹, can result in high numbers of false positives, leading to unnecessary interventions with associated risks and low user acceptance. Moreover, current false positive reduction algorithms often were developed for chest radiograph images or thick slice CT scans, and do not necessarily perform well on data originated from HRCT. ¹ Options to improve the performance of the computer aided detection of lung nodules in thin-slice CT. 2003, Philips Research Laboratories: Hamburg, and by Wiemker, R., T. Blaffert, in their: Computer Aided Tumor Volumetry in CT Data, Invention disclosure. 2002, Philips Research, Hamburg

To that end, the inventive CAD/FPR systems and methods include a CAD sub-system or process to identify candidate regions, and segment the regions. During training, the segmented regions within the set of training data are passed to a feature extractor, or a processor implementing a feature extraction process. The inventions address the problem known in the art as the biased goal problem, or unbalanced data set problem by implementation of the stratification method described in detail below. Feature extraction obtains a feature pool consisting of 3D and 2D features from the detected structures. The feature pool is passed to a genetic algorithm (GA) sub-system, or GA processor (post CAD), which processes the feature pool to realize an optimal feature sub-set. An optimal feature subset includes those features that provide sufficient discriminatory power for the SVM, within the inventive CAD or FPR system, to classify the candidate regions/volumes.

Thereafter, the CAD processes “new” image data, segmenting candidate regions found in non-training data. The sub-set of features (as determined during training) is extracted from the candidate regions, and used by the “trained” classifier (SVM) to decide whether the features of the candidate allow proper classification with proper specificity. The inventive FPR or CAD systems are able to thereby accurately, and with sufficient specificity, detect small lung nodules in high resolution and thin slice CT (HRCT), similar in feature to those comprising the training set, and including the new and novel 3D-based features. For example, HRCT data with slice thickness <=1 mm provides data in sufficient detail that allows for detection of very small nodules. The ability to detect smaller nodules requires new approaches to reliably detect and discriminate candidate regions, as set forth in the claims hereinafter.

A preferred embodiment of an FPR system 400 of the invention will be described broadly with reference to FIG. 1. FPR system 400 includes a CAD sub-system 420, for identifying and segmenting regions or volumes of interest that meet particular criteria, and an FPR subsystem 430. Preferably, the CAD sub-system 420 includes a CAD processor 410, and may further include a segmenting unit 430, to perform low level processing on medical image data, and segmenting same. Those skilled in the art will understand that CAD systems must perform a segmenting function to delineate candidate regions for further analysis, whether the segmenting function is implemented as a CAD sub-system, or as a separate segmenting unit, to support the CAD process (such as segmenting unit 430). The CAD sub-system 420 provides for the segmenting of candidate regions or volumes of interest, e.g., nodules, whether operating on training data or investigating “new” candidate regions, and guides the parameter adjustment process to realize a stable segmentation.

In training mode, feature extraction is crucial as it greatly influences the overall performance of the FPR system. Without proper extraction of the entire set or pool of features, the GA processor 450 may not accurately determine an optimal feature sub-set with the best discriminatory power and the smallest size (in order to avoid over-fitting and increase generalizability). A pool of features is extracted or generated by a feature extraction unit 440, comprising the FPR sub-system 430. The pool of features is then operated upon by a Genetic Algorithm processor 450, to identify a “best” sub-set of the pool of features. The intent behind the GA processing is to maximize the specificity to the ground truth by the trained CAD system, as predicted by an SVM 460, when using the feature sub-sets to operate upon non-training data. That is, GA processor 450 generates or identifies a sub-set of features, which when used by the SVM after training, increase specificity in the identification of regions in the segmented non-training data. The GA-identified sub-set of features is determined (during training only) with respect to both the choice of and number of features that should be utilized by the SVM with sufficient specificity to minimize false positive identifications when used on non-training data. That is, once trained, the CAD system no longer uses the GA when the system operates on non-raining data.

A GA-based feature selection process is taught by commonly owned, co-pending Philips application number US040120 (ID disclosure # 779446), the contents of which are incorporated by reference herein. The GA's feature subset selection is initiated by creating a number of “chromosomes” that consist of multiple “genes”. Each gene represents a selected feature. The set of features represented by a chromosome is used to train an SVM on the training data. The fitness of the chromosome is evaluated by how well the resulting SVM performs. In this invention, there are three fitness functions used: sensitivity, specificity, and number of features included in a chromosome. The three fitness functions are ordered with different priorities; in other words, sensitivity has 1st priority, specificity 2nd, and number of features the 3rd. This is called a hierarchical fitness function. At the start of this process, a population of chromosomes is generated by randomly selecting features to form the chromosomes. The algorithm (i.e., the GA) then iteratively searches for those chromosomes that perform well (high fitness).

At each generation, the GA evaluates the fitness of each chromosome in the population and, through two main evolutionary operations, mutation and crossover, creates new chromosomes from the current ones. Genes that are in “good” chromosomes are more likely to be retained for the next generation and those with poor performance are more likely to be discarded. Eventually an optimal solution (i.e., a collection of features) is found through this process of survival of the fittest. And by knowing the best feature subset, including the best number of features to realize false positive reduction (FPR) that reduces the total number of misclassified cases. After the feature subset is determined, it is used to train an SVM.

As mentioned above, the unbalanced training case problem refers to the situation in machine learning where the number of cases in one class is significantly fewer than those in another class. It is well known that such unbalance will cause unexpected behavior for machine learning. One common approach adopted by the machine learning community is to rebalance them artificially using “up-sampling” (replicating cases from the minority) and “down-sampling” (ignoring cases from the majority). Provost, F. “Learning with Imbalanced Data Sets 101,” AAAI 2000. The novel stratified method as taught and claimed hereby is specifically suitable for addressing the biased goal approach and overcoming the unbalanced case number problem.

After training, CAD sub-system 420 delineates the candidate nodules (including non-nodules found in the non-training data) from the background by generating a binary or trinary image, where nodule-, background- and lung-wall (or “cut-out”) regions are labeled. Upon receipt of the gray-level and labeled candidate region or volume, the feature extractor 440 calculates (extracts) any relevant features, such as 2D and 3D shape features, histogram-based features, etc., as a pool of features. The features are provided to the SVM, which already trained on the optimized feature sub-sets extracted from training data.

Those skilled in the art should understand that SVMs map “original” feature space to some higher-dimensional feature space, where the training set is separable by a hyperplane, as shown in FIG. 2. The SVM-based classifier has several internal parameters, which may affect its performance. Such parameters are optimized empirically to achieve the best possible overall accuracy. Moreover, the feature values are normalized before being used by the SVM to avoid domination of features with large numeric ranges over those having smaller numeric ranges, which is the focus of the inventive system and processes taught hereby. Normalized feature values also render calculations simpler. And because kernel values usually depend on the inner products of feature vectors, large attribute values might cause numerical problems. The scaling to the range of [0,1] is done as

x′=(x−mi)/(Mi−mi),

where,
x′ is the “scaled” value;
x is the original value;
Mi is the maximum feature value; and
mi is the minimum feature value.

The inventive FPR system was validated using a lung nodule dataset that included training data or regions whose pathology is known, utilizing what may be referred to as a “leave-one-out and k-fold validation”. The validation was implemented and the inventive FPR system was shown to reduce the majority of false nodules while virtually retaining all true nodules.

FIG. 3 is a flow diagram depicting a process, which may be implemented in accordance with the present invention. In FIG. 3, box 500 represents training a classifier on a set of medical image training data for which a clinical ground truth about particular regions or volumes of interest is known. The step may include training a classifier on a set of medical image training data selected to include a number of true and false nodules and automatically segmented. A feature pool is identified/extracted from each segmented region and volume within the training data, and processed by genetic algorithm processor to identify an optimal feature subset, upon which the support vector machine is trained. It is here that the stratified method for lung nodule false positive reduction is implemented.

Box 510 represents a step wherein if the training data includes an unbalanced number of true and false positives, a stratification process is implemented. Box 520 represents a post-training step of detecting, within new or non-training medical image data, the regions or volumes that are candidates for identification as to the ground truth, e.g., nodules or non-nodules. Box 530 represents the step of segmenting the candidate regions, and Box 540 represents the step of processing the segmented candidate regions to extract those features, i.e., the sub-set of features, determined by the GA to be the most relevant features for proper classification. Then, as shown in block 550, the support vector machine identifies the true positive identifications of non-training candidate regions with improved specificity, and maintaining sensitivity.

For that matter, as shown in box 510, a detailed description for the method illustrated in FIG. 5, where step 1 shows that the false nodule set is divided into three subsets based on nodule size. The case number distribution is shown below in the statistical analysis as seen in the table identified as “Number of cases” within FIG. 6.

In step 2, machine learning uses the largest false nodules (e.g. >4 mm) and all true nodules. The first reason for choosing the largest false nodules is the comparable number of cases as true nodules. The second reason is that image features extracted from large false nodules are believed to be more discriminative. The specific machine learning technique we use is Support Vector Machines (SVMs).

In step 3, a classifier is generated based on machine learning. Since the case numbers in both classes are comparable, the classifier is able to retain almost all true nodules and reduce close to 90% of the large false nodules after applying different cross-validation methods.

In step 4, the classifier mentioned in Step 3 is applied to the remaining smaller false nodules and the result shows that more than half of the false nodules are removed. Overall, the stratified approach proves to be a good method to overcome the unbalanced case problem. For biased goal problems because it first ensures as many true nodules are retained (first priority), then reduces false nodules (second priority). Therefore, this approach differs from other approaches to solve unbalanced data set problems that seek to raise the overall classification accuracy, i.e. same priority on reducing misclassified cases for both sides. It is specifically useful for such biased goal problems as lung nodule false positive reduction.

It is significant to note that software required to perform the inventive methods, or which drives the inventive FPR classifier, may comprise an ordered listing of executable instructions for implementing logical functions. As such, the software can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

It should be emphasized that the above-described embodiments of the present invention, particularly, any “preferred” embodiment(s), are merely possible examples of implementations that are merely set forth for a clear understanding of the principles of the invention. Furthermore, many variations and modifications may be made to the above-described embodiments of the invention without departing substantially from the spirit and principles of the invention. All such modifications and variations are intended to be taught by the present disclosure, included within the scope of the present invention, and protected by the following claims.

1. A method for computer-assisted detection (CAD) of regions or volumes of interest (“regions”) within medical image data that includes CAD processing to detect and delineate candidate regions, and post-CAD machine learning in a training phase to maximize specificity and reduce the number of false positives reported after processing non-training data, which method includes the steps of:
training a classifier on a set of medical image training data selected to include a number of regions known to be true and known to be false for a ground truth, identifying and segmenting the regions using said CAD processing, extracting features to create a pool of features to qualify the regions, applying a genetic algorithmic processor to the pool of features to determine a minimal sub-set of features for use by a support vector machine (SVM) to identify candidate regions within non-training data with improved specificity, wherein if the medical image training data is unbalanced, implementing a stratification process to the unbalanced data;
detecting, after training, within non-training data, candidate regions;
segmenting the candidate regions identified within the non-training data;
extracting a set of candidate features relating to each segmented candidate region; and
mapping candidate regions into ground truth space based on the set of candidate features with practical specificity in accord with the training process.

2. The method as set forth in claim 1, wherein the step of training further includes determining both the size of the sub-set of features optimized by the GA during training, for each candidate region in the training data, and the actual features comprising the sub-sets.

3. The method as set forth in claim 1, wherein the step of training further includes defining a pool of features identified within each region within the training data as a chromosome, where each gene represents a feature, and where the genetic algorithm initially populates the chromosomes by random selection of features, and iteratively searches for those chromosomes that have higher fitness, wherein the evaluation is repeated for each generation, and using mutation and crossover, generates new and more fit chromosomes during the training phase.

4. The method as set forth in claim 3, wherein the determining includes applying the GA in two phases, including:
a.) identifying each chromosome as to both its set of features, and the number of features; and
b.) analyzing, for each chromosome, the identified set of features, and the identified number of features, to determine the optimal size of the feature based on the number of occurrences of different chromosomes and the number of average errors.

5. The method as set forth in claim 1, wherein the step of training includes identifying wall pixels utilizing filter masks.

6. The method as set forth in claim 1, wherein if the data is unbalanced such that the number of false nodules is much greater than the number of true nodules, the stratification process chooses a number of false nodules based on a criteria such that the number of false nodule and true nodules is balanced.

7. A computer readable medium comprising a set of computer readable instructions, which upon downloading to a general purpose computer, implements a method as set forth in claim 1.

8. A system for detecting and identifying regions and/or volumes of interest (“regions”) within medical image data, including a CAD sub-system, and a false positive reduction (FPR) subsystem, for mapping regions to one of two ground truth states with improved specificity thereby minimizing the number of false positives reported by the system, comprising:
a CAD sub-system for identifying and delineating regions of interest detected within image data;
a false positive reduction sub-system in communication with the CAD sub-system, which is first trained on a set of training data, and subsequently operate upon candidate regions within non-training data with improved specificity, comprising:
a feature extractor for extracting a pool of features corresponding to each CAD-delineated candidate region;
a genetic algorithm in communication with the feature extractor to determine an optimal sub-set of features from pool of features of the CAD-delineated regions used in training; and
a support vector machine (SVM) in communication with the feature extractor and GA, which maps each CAD-delineated candidate region detected in non-training data, post-training, based on the optimal subset of features;
wherein the system is trained on imaging data including candidate regions with known ground truth, by extracting a pool of features from each segmented region, using the GA to identify an optimal sub-set of extracted features in order that the system displays sufficient discriminatory power during operation on non-training data in order to map the candidate regions with improved specificity, and wherein in the case where a total of true positives is outweighed by the number of false positives found in the training set, a stratification sub-system rearranges the training data such that there are approximately equal numbers of true and false positives in the training.

9. The medical image classification system set forth in claim 8, where the CAD subsystem further includes a segmenting sub-system, which provides for reader input during the training to better delineate regions that are used for training.

10. The medical image classification system as set forth in claim 8, wherein the GA operates upon a hierarchical fitness paradigm, in both training and operation on non-training data.

11. A method for classifying objects detected within medical imaging data that results a marked reduction in false positive classifications, comprising the steps of:
CAD processing to detect and delineate objects present in the medical imaging data;
post-CAD processing to generate a feature set with sufficient discriminatory power such that delineated objects may be classified with maximum specificity;
wherein during a training phase, a set of known training data is CAD-processed to segment objects within the training data, a pool of features extracted/calculated from/for the segmented objects, and machine learning optimizes a sub-set of features from the pool of features, wherein if the training set has an unbalanced number of regions that are true positives and false positives, training is implemented in accord with a stratification process to train using balanced, as distinguished from unbalanced training data and wherein after training, candidate objects delineated by the CAD process are post-CAD processed, including object feature extraction, to classify the objects with high specificity in view of the post-CAD machine learning.

12. A method for training a classifier for the classification of morphologically interesting regions detected within medical imaging data, where the training includes choosing data to train the classifier in accordance with a stratification method, the stratification method comprising:
separating the pool of false positive regions into N subsets based on region size, such that the Nth subset includes the largest regions subset;
implementing a machine learning process using the Nth subset and all true regions;
generating the classifier based on the machine learning; and
applying the classifier to each of the remaining N−1 subsets.
